(19) United States
(12) Patent Application Publication
(10) Pub. No.: US 2011/0168722 A1
(43) Pub. Date: Jul. 14, 2011

(54) FULL CONTAINMENT TANK

(75) Inventors: Ned Baudat, New Braunfels, TX (US); Joe A. Nelson, II, Flint, TX (US)

(73) Assignee: BDT Consultants Inc.

(21) Appl. No.: 12/686,526

(22) Filed: Jan. 13, 2010

(51) Int. Cl. F17C 3/04; B23P 11/00

(52) U.S. Cl. 220/560.12; 29/428

(57) ABSTRACT

A tank that may include an inner containment membrane defining a containment volume, an exterior structural shell enclosing the inner containment membrane, and a contingent containment membrane sandwiched between the shell and the inner membrane. The tank may further include a first insulation layer between the contingent membrane and the shell, and a second insulation layer between the inner membrane and the contingent membrane. The tank may further include first or second insulation layers that include a reinforcing beam comprised of foamed or block insulation.

### RELATED APPLICATION DATA

Not applicable.

### BACKGROUND OF THE INVENTION

1. Field of the Invention

The present invention relates to tanks, and to methods of making and using such tanks. In another embodiment, the present invention relates to LNG storage tanks, and to methods of making and using such LNG storage tanks. In even another embodiment, the present invention relates to full containment LNG storage tanks, and to methods of making and using such LNG storage tanks. In still even other embodiments, the present invention relates to methods for modifying tanks to provide additional containment, and to such modified tanks and their method of making and use.

2. Brief Description of the Related Art

Tanks and construction thereof are well known. When the need arises for large tanks in remote environments, the current response is to either ship in a completed tank, or fabricate the tank remotely usually from pre-fabricated parts. In some remote locations it is either technically impossible or cost prohibitive to ship in a whole tank, and therefore remote fabrication is the only alternative.

As the time requirement for fabricating a rather large tank may be on the order of several months to years, and require large number of workers, remote fabrication becomes expensive requiring in addition to salary costs, costs for living expenses such as housing, food, water, heating or cooling, which may sometimes be well beyond the obvious salary cost.

Improvements in the assembly time for such tanks would reduce these manpower costs. There are a number of patents directed to tanks, including the following.

U.S. Pat. No. 3,795,573, issued Mar. 5, 1974, to Smith et al., discloses a liner, for use in lining a cryogenic tank comprising of multiple layers of woven polyester fibers such as woven polyethylene terephthalate fibers and stress-oriented polyethylene terephthalate films, and aluminum.

U.S. Pat. No. 3,929,247, issued Dec. 30, 1975, to Borup; Herbert H., discloses an internally insulated tank for the transportation and storage of cryogenic liquids, such as liquified natural gas. The inner surfaces of the tank are lined with rigid, closed cell polyurethane foam to which is bonded a thin impervious sheet material, such as aluminum foil.

U.S. Pat. No. 4,101,045, issued Jul. 18, 1978, to Roberts et al., discloses a cryogenic container adapted to store or transport liquified gases, the container including an outer tank formed by walls which have thermal insulation properties and are structurally capable of supporting the load, the walls incorporating a liquid and gas-impervious secondary barrier. Received within the outer tank and readily removable therefrom is a prefabricated independent inner tank constituted by a flexible bladder whose geometry roughly conforms to the contours of the inner surface of the outer tank. The bladder is formed of a synthetic plastic fabric material that is coated to render it liquid and gas-impervious to define a primary barrier, which coated fabric material maintains its flexibility and other physical characteristics at cryogenic temperatures and has sufficient structural strength to sustain the cryogenic liquid load without any danger of rupture even in those areas thereof in which the bladder does not fully conform to the contour of the outer tank surface and is not backed thereby.

U.S. Pat. No. 4,170,952, issued Oct. 16, 1979, to McCown, discloses a cryogenic insulation system for containers for storage of cryogenic liquefied gases such as LNG, comprised of a low temperature resistant metal, preferably high nickel steel, primary membrane or liner supported by a primary layer of reinforced foam insulation, and a secondary liner positioned adjacent to and sandwiched between the primary layer of foam insulation and a secondary layer of reinforced foam insulation. The preferably high nickel steel primary liner or membrane is supported above the primary foam insulation layer by stiffened ends of the reinforcement fibers which extend above the surface of the foam insulation, providing a small gap between the foam and the membrane. There is provided at corners, particularly at 90.degree. corners, and disposed within the primary and secondary foam insulation layers, a cooperating system of a coupler attached to the container wall or ship hull, ball joint coupler bolt and plywood support attached to the primary high nickel steel liner, to transfer loads from the liner to the container wall or ship hull, while permitting the corner structure to move under loads applied by the liner. Insulation support panels are provided for supporting the insulation system against the container wall or ship hull employing adhesive plastic beads or modules which are cured to form a rigid load carrying bearing for the support panels, and to maintain the panels spaced from the container wall or ship hull.

U.S. Pat. No. 4,207,827, issued Jun. 17, 1980, to Gondouin, discloses a system, tooling and method of construction of cryogenic tanks for LNG tankers and for LNG storage. Prefabricated rigid insulating panels of great length, made of a fiberglass reinforced prestressed foam enclosed in a gas tight envelope and covered on their inner face by a folded metal membrane are glued directly to the cavity walls of the load bearing structure of a cryogenic tank by means of variable thickness adhesive mastic strips, which also separate channels for a gas circulation against the panels' back face. The beveled edge surfaces of adjacent panels are rigidly bonded under pressure. Panel handling, gluing operations, and membrane welding inside the closed space of a tank are done using telescopic towers fitted with four mobile arms, one of them supporting a worker-carrying bucket. Complete self standing inner tanks may also be assembled outside and inserted into the cavity of a vessel before it is covered over. Inflated air hoses attached to the outer faces of the inner tank center it inside the cavity during the injection and curing of a liquid thermosetting bonding agent between the cavity walls and the inner tank. The hoses subsequently provide channels for a gas circulation against the back face of each panel for monitoring its integrity.

U.S. Pat. No. 5,419,139, issued May 30, 1995, issued to Blum et al., discloses an aerospace vehicle fuel pressure, or cryogen tank apparatus that includes a tank load bearing wall of composite laminate construction that is lined with a film laminate liner that includes at least two metalized layers bonded with adhesive with the metalized coatings facing each other. The liner is bonded to the load bearing wall with an adhesive. The improved tank apparatus is able to withstand extreme pressure and extreme temperature conditions, and while containing cryogens such as liquid helium and liquid hydrogen.

U.S. Pat. No. 5,833,919, issued Nov. 10, 1998, to Hong et al., discloses an Fe—Mn—Cr—Al cryogenix alloy and method of making, having high ductility, strength, toughness and corrosion-resistance, and a process for preparing the same. The cryogenic structural alloy is prepared by the steps of: air-induced melting of a metallic alloy composition; hot-rolling the melted alloy; and, solution heat treatment of the hot-rolled alloy. The alloy possesses a higher elongation, corrosion-resistance and toughness than 9% Ni steel; and, therefore, it can be applied for LNG-related facilities including storage tanks, transporting pipes and valves, and transport ships, etc.

U.S. Pat. No. 6,085,528, issued Jul. 11, 1990, to Woodall et al., discloses a system for processing, storing, and transporting liquefied natural gas. A container is provided for storing pressurized liquefied natural gas, and is constructed from an ultra-high strength, low alloy steel containing less than 9 wt % nickel and having a tensile strength greater than 830 MPa (120 ksi) and a DBTT lower than about −73 C. (−100 F.).

U.S. Pat. No. 6,528,012, issued Mar. 4, 2003, to Nishimoto et al., discloses a welded structure made of low thermal expansion coefficient alloy and welding material therefore.

U.S. Patent Publication No. 2006/0086741, published Apr. 27, 2006, to Bacon et al., discloses a low temperature/cryogenic liquid storage structure that has an inner tank liner made of conventional low-temperature/cryogenic tank-quality plates with structural members that provide flexibility. The plates are mounted on connectors that accommodate movement of the liner with respect to the bearing wall. The plates have thickness of between 1/16″ and ½″ inch and a surface area of at least 100 square feet. The structural members are conventional construction materials that have a wall thickness of more than 1/16″. Load-bearing insulation extends between the outer surface of the inner tank liner and the inner surface of an outer bearing wall that is impervious to vapor.

U.S. Patent Publication No. 2006/0131304, published Jun. 22, 2006, to Yang et al., discloses liquid tank system adapted to store liquefied natural gas (LNG). The LNG storage container includes a sealing wall directly contacting liquid contained in the tank and a structural wall, which is an exterior wall or inner structure integrated with the exterior wall. The container further includes a plurality of connectors mechanically connecting the sealing wall and the structural wall and an intermediate wall structure positioned between the structural wall and the interior wall. The intermediate wall structure is configured to move relative to at least one of the interior wall and the structural wall.

U.S. Pat. No. 7,100,261, issued Sep. 5, 2006, to Gulati, discloses a liquefied natural gas storage tank. These substantially rectangular-shaped tanks for storing liquefied gas, are especially adapted for use on land or in combination with bottom-supported offshore structure such as gravity-based structures (GBS). A tank according to this invention is capable of storing fluids at substantially atmospheric pressure and has a plate cover adapted to contain fluids and to transfer local loads caused by contact of said plate cover with said contained fluids to a grillage of stiffeners and stringers, which in turn is adapted to transfer the local loads to an internal truss frame structure. Methods of constructing these tanks are also provided.

U.S. Pat. No. 7,171,916, issued Feb. 6, 2007, to Yang et al., discloses a ship with liquid tank adapted to store liquefied natural gas (LNG). The LNG storage container includes a sealing wall directly contacting liquid contained in the tank and a structural wall, which is an exterior wall or inner structure integrated with the exterior wall. The container further includes a plurality of connectors mechanically connecting the sealing wall and the structural wall and an intermediate wall structure positioned between the structural wall and the interior wall. The intermediate wall structure is configured to move relative to at least one of the interior wall and the structural wall.

U.S. Pat. No. 7,325,288, issued Feb. 5, 2008, to Yang et al, discloses a method for manufacturing liquid tank and ship with a liquid tank. This liquid container is adapted to store liquefied natural gas (LNG), and includes a sealing wall directly contacting liquid contained in the tank and a structural wall, which is an exterior wall or inner structure integrated with the exterior wall. The container further includes a plurality of connectors mechanically connecting the sealing wall and the structural wall and an intermediate wall structure positioned between the structural wall and the interior wall. The intermediate wall structure is configured to move relative to at least one of the interior wall and the structural wall.

U.S. Pat. No. 7,553,107, issued Jun. 30, 2009, to Epinasse, discloses an underwater storage installation for a cryogenic liquid, such as LNG.

U.S. Pat. No. 7,597,212, issued Oct. 6, 2009, to Yang et al., discloses modular walls for use in building liquid tank that may be adapted to store liquefied natural gas (LNG). The LNG storage container includes a sealing wall directly contacting liquid contained in the tank and a structural wall, which is an exterior wall or inner structure integrated with the exterior wall. The container further includes a plurality of connectors mechanically connecting the sealing wall and the structural wall and an intermediate wall structure positioned between the structural wall and the interior wall. The intermediate wall structure is configured to move relative to at least one of the interior wall and the structural wall.

All of the patents, applications and publications cited in this specification, are herein incorporated by reference.

However, in spite of the above advancements, there exists a need in the art for tanks and better methods of making and using tanks.

These and other needs in the art will become apparent to those of skill in the art upon review of this specification, including its drawings and claims.

### SUMMARY OF THE INVENTION

It is an object of the present invention to provide for tanks and methods of making and using tanks.

This and other objects of the present invention will become apparent to those of skill in the art upon review of this specification, including its drawings and claims.

According to one embodiment of the present invention, there is provided a containment apparatus that may include an inner containment layer defining a containment volume. The containment apparatus may also include a structural shell positioned around the inner containment layer. The containment apparatus may also include a contingent containment layer positioned between the inner containment layer and the structural shell, a first insulation layer positioned between the contingent containment layer and the structural shell and/or a second insulation layer positioned between the inner containment layer and the contingent containment layer.

According to another embodiment of the present invention, there is provided a method of making a containment apparatus. The method may include one or more of the following step in any order: (A) erecting an outer structural shell defining an inner volume; (B) positioning a first bottom insulation layer at a bottom of the inner volume; (C) positioning a second bottom insulation layer on top of the first bottom insulation layer; (D) installing a part of an contingent containment layer within the inner volume defining an first annular insulation space between the contingent containment layer and the outer structural shell; (E) installing first annular insulation into the first space; (F) installing a part of an inner containment layer within the inner volume defining a second annular insulation space between the inner containment layer and the contingent containment layer; (G) repeating steps (D)-(F) until the contingent containment layer and the inner containment layer are complete; and/or (H) installing second annular insulation into the second space.

According to even another embodiment of the present invention, there is provided a method of making a containment apparatus. The method may include one or more of the following steps in any order: (A) erecting an outer structural shell defining an inner volume; (B) positioning a first bottom insulation layer at a bottom of the inner volume; (C) positioning a contingent containment bottom layer on the initial insulation layer; (D) positioning a second bottom insulation layer on top of the first bottom insulation layer; (E) positioning the inner containment bottom layer on the second bottom insulation layer; (F) installing a part of an contingent containment layer within the inner volume defining an first annular insulation space between the contingent containment layer and the outer structural shell; (G) installing first annular insulation into the first space; (H) installing a part of an inner containment layer within the inner volume defining a second annular insulation space between the inner containment layer and the contingent containment layer and including installation of reinforcing beams as required in the second annular insulation space; (I) repeating steps (F)-(H) until the contingent containment layer and the inner containment layer are complete; and/or (J) installing second annular insulation into the second space after each step(H) or after step (I) as needed.

These and other embodiments of the present invention will become apparent to those of skill in the art upon review of this specification, including its drawings and claims.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a view of tank 100 having a portion cutaway revealing inner containment membrane 111, contingent containment membrane 105, and tank shell 103.

FIG. 2 is a top view of a horizontal cross-section view of tank 100 of FIG. 1.

FIG. 3 is a side view of a vertical cross-section view of part of tank 100 of FIG. 1.

### DETAILED DESCRIPTION OF THE INVENTION

Certain non-limiting embodiments of the present invention provide tanks that may find utility in many locations and environments, non-limiting examples include offshore or remote locations. In further non-limiting embodiments, the tanks of the present invention may be full containment tanks, and while may be useful for storage of a wide variety of materials, may find utility with cryogenic fluids, including but not limited to LNG, Ethane, Propane, Ammonia, Liquid Nitrogen and Oxygen and other fluids. A very specific non-limiting embodiment of the present invention provides a full containment LNG tank.

Some non-limiting embodiments of the present invention provide improvements to conventional single containment designs. Other non-limiting embodiments provide methods for modifying or improving conventional single containment tank designs. With other non-limiting embodiments of the full containment tank of the present invention, the inner shell may be of conventional construction.

In the practice of certain non-limiting embodiments of the present invention, methods are provided whereby a tank can be fabricated, non-limiting examples include, at least by full or partial construction in a fabrication shop remote from the ultimate utilization site, or at least by constructing in-situ at, adjacent to, or nearby the ultimate utilization site from the ground up or from part or all pre-constructed components. The tank may be a full containment tank, and may be utilized as an LNG tank. A mobile version of such a tank may be incorporated into a vehicle, trailer, train car, portable tank, or marine structure or vessel.

In some embodiments of the present invention, the tank may include an inner or primary containment system that is in contact with the material being contained and an outer structural shell. These embodiments may further include a secondary or contingent containment system positioned between the inner containment system and the outer shell in the event of failure of the inner containment system. This contingent system may include 1, 2, 3, 4, 5, 6, 7, 8, 9, 10, or more, additional layers of containment. It is believed that most commercial containment systems will adequately have 1 or 2 contingent layers, with 1 contingent layer being the most commercially common. Certainly, the risk of leak and the consequences of any leak are factors to consider in deciding how many contingent layers will be provided on any particular tank.

Of course, the materials of construction selected for the outer shell, inner containment layer and the contingent containment layer(s) may depend upon one or more of the engineering specifications/issues, the material being contained, the ambient weather environment in which the tank is situated (wind, weather, wind, sun, heat, cold, flooding, etc.), the structural stability of the environment (i.e., on ice, offshore, on landfill, near fault line or earthquake zone, etc.), economics, probability of leak, and the consequences of any leak, as well as any factor that may be considered. That being said, non-limiting examples of suitable materials of construction include carbon steel for the shell, 304 stainless for the contingent layer, and 9 Ni for the inner containment layer. Other non-limiting examples of suitable materials of construction include at least Aluminum, Titanium, Ni Alloys and other materials suitable for the specific services.

Support of the contingent containment system, may be achieved by an insulation layer that may be sandwiched between the contingent containment system and the inner containment system. While any suitable insulation may be utilized, non-limiting examples include foam insulation and block insulation. Support may also be provided in the nature of insulation structural members positioned between the contingent containment system and the inner containment system.

Support of the contingent containment system, may also be achieved by an insulation layer that may be sandwiched between the contingent containment system and the tank shell. While any suitable insulation may be utilized, non-limiting examples include foam insulation and block insulation. Support may also be provided in the nature of structural members positioned between the contingent containment system and the tank shell.

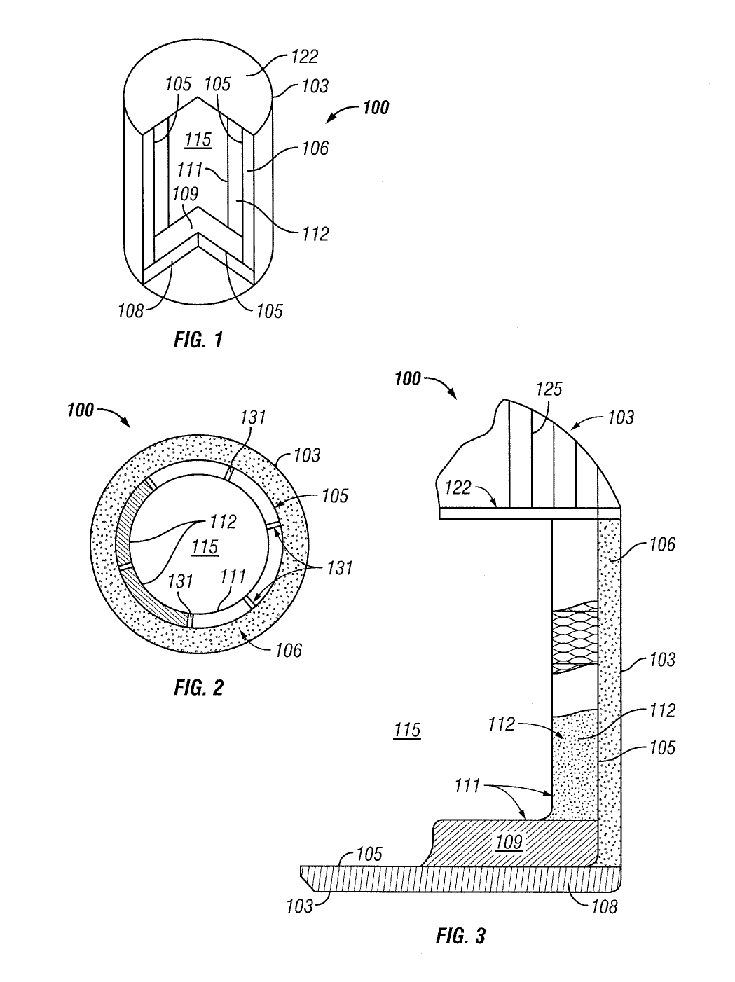

The present invention will now be further described by reference to FIGS. 1-3, which describe tank 100, a certain non-limiting embodiment of the of the present invention.

Non-limiting tank 100 may include an outer structural shell 103. While structural shell 103 may comprise any suitable material, in the non-limiting embodiment as shown, shell 103 comprises carbon steel. Structure shell 103 may be provide with any suitable finish, treatment or coating as may be desired, non-limiting examples include sealant, paint, coatings, and/or reflectant material.

Non-limiting tank 100 further may on the side of tank 100 include an insulation layer 106 abutting shell 103. On the bottom, this non-limiting tank 100 may include an insulation layer 108 abutting shell 103. While these insulation layers 106 and 108 may comprise any suitable insulation material, in the non-limiting embodiment as shown, insulation layer 106 comprises foamed insulation, and insulation layer 108 comprises block insulation. It should also be noted that insulation layers 106 and 108 may comprise the same or different insulation material.

In the non-limiting embodiment as shown, a contingent containment layer 105 may be provided which abuts insulation layer 106 and insulation layer 108 as shown. While contingent containment layer 105 may comprise any suitable material, in the non-limiting embodiment as shown, containment layer 105 comprises 304 stainless steel.

Non-limiting tank 100 may further include an inner containment layer 111 as shown that will define the containment volume 115. While inner containment layer 111 may comprise any suitable material, in the non-limiting embodiment as shown, containment layer 111 comprises 9 nickel.

Sandwiched on the side of tank 100 between inner containment layer 111 and contingent containment layer 105 is insulation layer 112. Sandwiched on the bottom of tank 100 between inner containment layer 111 and contingent containment layer 105 is insulation layer 109. While these insulation layers 109 and 112 may comprise any suitable insulation material, in the non-limiting embodiment as shown, insulation layer 112 comprises perlite insulation, and insulation layer 109 comprises block insulation. It should also be noted that insulation layers 109 and 112 may comprise the same or different insulation material.

In the non-limiting embodiment as shown, tank 100 may include support members, such as one or more beams 131, positioned between inner containment layer 111 and contingent containment layer 105 which may be provided to support membrane 105. These beams 131 may comprise any suitable structural material, including but not limited to foamed insulation, block insulation, wood, metal, composite materials, polymeric materials, and any other structural material.

In the non-limiting embodiment as shown, tank 100 may include a roof, such as a suspended roof 122 with reinforcing members 125.

In some non-limiting embodiments of making the tanks of the present invention, the outer shell tank may be utilized to provide a controlled and/or dry environment for welding the inner containment layer.

A non-limiting example of a method of making a tank can be described as follows. The outer structural shell 103 may be erected complete with roof 103 prior to starting erection of the inner containment and contingent containment layers. Insulation layer 108 may be installed to provide support for the bottom of contingent containment 105 installation and corner so insulation 109 may be installed. Insulation layer 109 may be installed to provide support for bottom and corner of inner containment 111. Next, the first course of contingent containment 105 may be installed. Next, insulation 106 may be installed to within a certain design distance of top of 105 (as a non-limiting example, approximately 1 foot). Next, inner containment 111 first course may be installed. Next, structural insulation beams 131 may be installed at required intervals. The above steps may be repeated until the inner containment 111 and contingent containment 105 are completed. At this point, perlite 112 may now be installed between containment layers 111 and 105. A suspended roof 122 with insulation is then installed above the inner and contingent tanks.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A containment apparatus comprising:
an inner containment layer defining a containment volume;
a structural shell positioned around the inner containment layer;
a contingent containment layer positioned between the inner containment layer and the structural shell;
a first insulation layer positioned between the contingent containment layer and the structural shell; and,
a second insulation layer positioned between the inner containment layer and the contingent containment layer.

2. The apparatus of claim 1 wherein at least one of the first or second insulation layers comprises a reinforcing beam.

3. The apparatus of claim 2, wherein the beam comprises material selected from foamed insulation, block insulation, wood, and structural material.

4. The apparatus of claim 1 wherein the second insulation layer comprises a reinforcing beam.

5. A method of making a containment apparatus, comprising the steps of
(A) erecting an outer structural shell defining an inner volume;
(B) positioning a first bottom insulation layer at a bottom of the inner volume;
(C) positioning a contingent containment bottom layer on the initial insulation layer;
(D) positioning a second bottom insulation layer on top of the first bottom insulation layer;
(E) positioning the inner containment bottom layer on the second bottom insulation layer;
(F) installing a part of an contingent containment layer within the inner volume defining an first annular insulation space between the contingent containment layer and the outer structural shell;
(G) installing first annular insulation into the first space;
(H) installing a part of an inner containment layer within the inner volume defining a second annular insulation space between the inner containment layer and the contingent containment layer and including installation of reinforcing beams as required in the second annular insulation space;
(I) repeating steps (F)-(H) until the contingent containment layer and the inner containment layer are complete;
(J) installing second annular insulation into the second space after each step(H) or after step (I) as needed.

6. A method of making a containment apparatus, comprising the steps of
(A) erecting an outer structural shell defining an inner volume;
(B) positioning a first bottom insulation layer at a bottom of the inner volume;
(C) positioning a second bottom insulation layer on top of the first bottom insulation layer;
(D) installing a part of an contingent containment layer within the inner volume defining an first annular insulation space between the contingent containment layer and the outer structural shell;
(E) installing first annular insulation into the first space;
(F) installing a part of an inner containment layer within the inner volume defining a second annular insulation space between the inner containment layer and the contingent containment layer;
(G) repeating steps (D)-(F) until the contingent containment layer and the inner containment layer are complete;
(H) installing second annular insulation into the second space.
